(19) United States
(12) Patent Application Publication
(10) Pub. No.: US 2009/0035499 A1
(43) Pub. Date: Feb. 5, 2009

(54) Bedroll Protector

(76) Inventor: Tom Wandel, Ebensburg, PA (US)

Correspondence Address: Jay M. Schloff;Intellipex PLLC, Suite 245, 30200 Telegraph Road, Bingham Frams, MI, 48025, US

(21) Appl. No.: 11/831,463

(22) Filed: Jul. 31, 2007

(51) Int. Cl. B32B 1/08

(52) U.S. Cl. 428/35.2

(57) ABSTRACT

Disclosed is a bedroll protector configured to store and transport a bedroll. The bedroll protector comprises an elongated substantially rectangular bag body with an openable flap or sheet for receiving a bedroll. The protector may be placed on the ground in an unrolled configuration to receive and insulate a user's bedroll from damp and dirty ground conditions. In one embodiment, the bedroll protector comprises waterproof material. In another embodiment, the protector comprises waterproof material on the side that engages the ground and water-resistant breathable material on the protector's opposite side. Upon receiving a bedroll, the bedroll protector may also be rolled up and secured in such position by accompanying straps to enable storage and transportation of the bedroll.

### FIELD OF THE INVENTION

The present invention generally relates to a sleeping bag cover, and more particularly, to a bedroll protector for storage, insulation, and transportation of a bedroll.

### BACKGROUND OF THE INVENTION

Today's sedentary but fast paced and hectic world leaves a person exhausted and drained. In order to rejuvenate themselves and to bring a fresh breeze to ones life, many people take the recourse of adventure sports or traveling in the wilderness. Popular pursuits in this vein are backpacking, camping, trekking, hiking, backcountry skiing, bike touring, canoeing and the like. Campers, trekkers, and backpackers seek to minimize the weight and bulk of gear carried by them by using lightweight gear.

For extended stays, the campers, trekkers, and backpackers generally carry a bedroll, such as a sleeping bag, a mattress and a backpack or knapsack filled with personal items such as food items, clothing, medicines and other articles used by them in their expeditions. Typically, any personal item stored in the backpack or knapsack is transported on the individual's back or is hand-carried. The bedroll is also generally rolled up into a bulky cylindrical package and is secured to the exterior of a knapsack, where it remains exposed to the elements.

Stuff bags or stuff sacks may be used by campers, trekkers, and backpackers to store and transport bedrolls. Such bags and sacks have limitations in providing adequate help in terms of compactly storing the bedroll. These stuff bags only serve the purpose of holding the bedrolls and are not of any additional functional help to the user. Additionally, campers, trekkers, and backpackers have to carry a separate mat to be used where they want to camp. This increases the load that the user must carry. A common problem with these mats is that they get easily soiled or damaged from direct contact with the ground and moisture thereon, making sleeping conditions miserable and unpleasant.

Several attempts have been made to provide a protective cover for the bedrolls that may be used by campers, trekkers, and backpackers. The protective covers of the existing art although provide some protection to the bedrolls but they are mostly limited in their functionality, and are structurally complex and expensive. For example, protective covers of the prior art do not serve the simultaneous functions of allowing the user to store and transport a bedroll and to use the cover as insulation from damp or uneven ground on which the user chooses to place his or her bedroll.

Therefore, as a consequence of the foregoing situation, there exists a continuing need in the art for a bedroll protector for storing and transporting a bedroll compactly and with ease. Further, there is a need felt in the art for a bedroll protector which, besides permitting storage and transportation of the bedroll, also serves as an insulating barrier between the user's bedroll and damp, dirty, muddy, or uneven ground.

### SUMMARY OF THE INVENTION

In view of the foregoing disadvantages inherent in the prior art, the general purpose of the present invention is to provide a bedroll protector for campers, trekkers, and backpackers to include all the advantages of the prior art, and to overcome the drawbacks inherent therein

In one aspect, the present invention provides a bedroll protector for holding and protecting a bedroll. The bedroll protector is an elongated substantially rectangular bag body. The bedroll protector comprises a lower portion configuring a perimeter edge and an upper portion integrally connected to the lower portion at the perimeter edge. The upper portion has a flap openable about the upper portion. The flap is openable in a manner such that the flap upon opening configures a slot for receiving a bedroll therethrough and onto the lower portion.

In another aspect, the present invention in an unrolled position provides a portable mat system that insulates a bedroll and a user from damp, dirty, and muddy ground conditions. In one embodiment, the present invention insulates the bedroll from exterior conditions, effectively increasing the temperature rating of the bedroll.

In another aspect, the present invention provides a compact and waterproof carrier for bedrolls.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a top perspective view of a bedroll protector 100 in an unrolled position, according to an exemplary embodiment of the present invention;

FIG. 2 is a bottom perspective view of the bedroll protector 100 in an unrolled position, according to an exemplary embodiment of the present invention;

FIG. 3 is a perspective view of the bedroll protector 100 in an unrolled position with a flap lying open on one side, according to an exemplary embodiment of the present invention;

FIG. 4 is a perspective view of the bedroll protector 100 in an unrolled position with a flap lying on one side and a bedroll positioned inside therein, according to an exemplary embodiment of the present invention; and

FIG. 5 is a perspective view of the bedroll protector 100 in a rolled up position, according to an exemplary embodiment of the present invention.

FIG. 6 is a perspective view of a bedroll protector 100a in a disassembled state in accordance with an exemplary embodiment of the present invention.

FIG. 7 is a perspective view of a bedroll protector 100a in accordance with an exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present invention provides a novel and economically advantageous solution to longstanding problems faced by trekkers, campers and backpackers by providing means to compactly store bedrolls, sleeping bags, mats and other articles of utility used by them in their expeditions with greater ease and efficiency. Besides being a carryall for storing sleeping bags, mats and the like, the present invention also provides an improved portable waterproof mat system for a user.

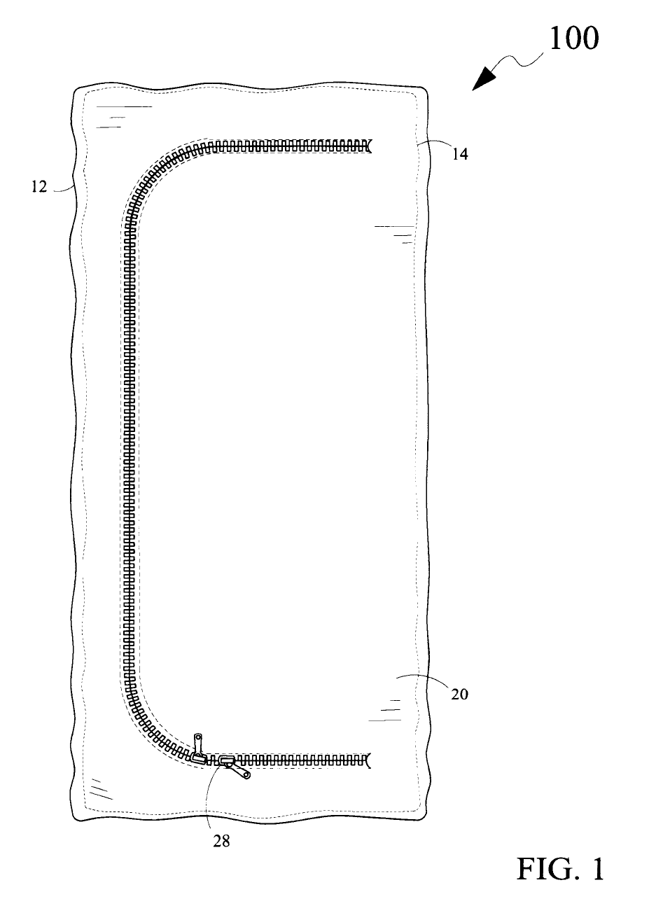

Referring to FIGS. 1-5, a bedroll protector 100 for storing and protecting a bedroll is provided. The bedroll protector 100 comprises an elongated substantially rectangular bag body having a lower portion 10 and an upper portion 20 (See FIGS. 1 & 2). The lower portion 10 configures a perimeter edge 12 and the upper portion 20 is integrally connected to the lower portion 10 at a seam 14 along the perimeter edge 12 (See FIG. 1). The lower portion 10 and the upper portion 20 are substantially of the same size. The integral connection of the upper portion 20 and the lower portion 10 along the perimeter edge 12 configures a hollow space therebetween.

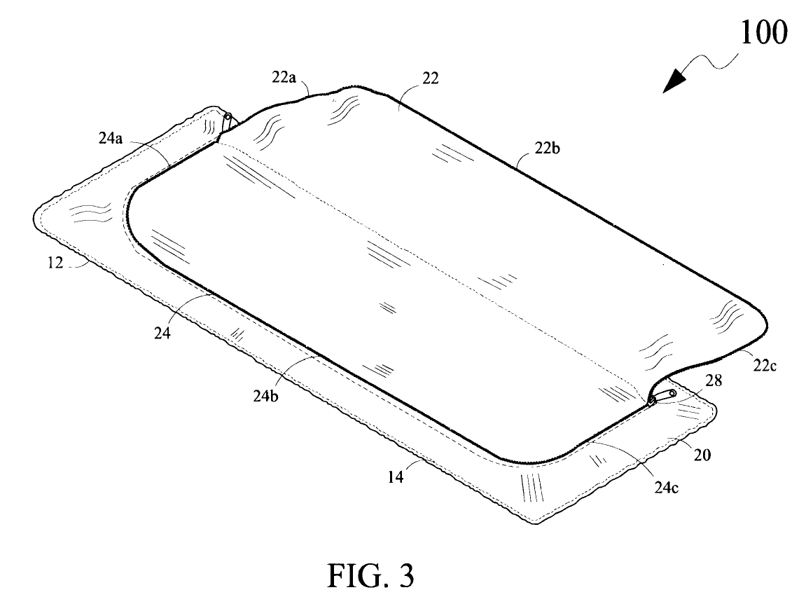

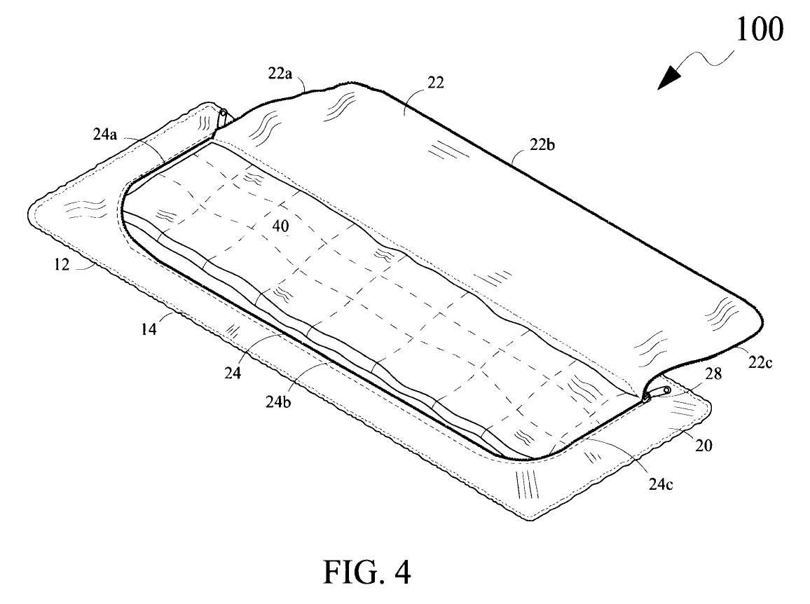

The upper portion 20 has a flap 22 (See FIG. 3) openable about the upper portion 20. The flap 22 is a non-detachable three side openable flap configured on the upper portion 20. The flap 22 has engagement features disposed on all three sides 22a, 22b and 22c of the flap 22. The flap 22 is configured in a manner such that the flap 22 upon opening configures a slot 24 in the upper portion 20. Three sides 24a, 24b and 24c of the slot 24 have complementary engagement features capable of removably engaging with engagement features on three sides 22a, 22b and 22c of the flap 22. In one embodiment, the engagement features and the complementary engagement features configure a zipper arrangement 28 for attaching the flap 22 with the upper portion 20. The slot 24 is configured to receive a bedroll 40 therethrough and onto the lower portion 10 (See FIG. 4). The bedroll 40 as used herein may be any sleeping gear, such as a sleeping bag, quilt, blanket and the like.

Preferably, the bedroll protector 100 is made from a durable, waterproof and non-breathable material. The material is flexible and non-susceptible to extreme temperature conditions. In one embodiment of the present invention, the waterproof non-breathable material is flexible polyethylene with a fineness of 1,000 deniers and being capable of withstanding temperature as low as −70° F. Due to the integral connection between the lower portion 10 and the upper portion 20, the bedroll protector 100 configures a double polylaminated construction. The bedroll protector 100 may be configured in variety of shapes and sizes to suit the preference of multitude of people. In one embodiment of the present invention, the bedroll protector 100 is rectangular in shape having a length of 96 inches, a folded breadth of 36 inches and an unfolded breadth of 72 inches.

Along the perimeter edge 12, the lower portion 10 is securely attached to the upper portion 20 at the seam 14 by means of stitching or other suitable connection means known in the art. In one embodiment of the present invention, the lower portion 10 and upper portion 20 are electronically heat-sealed at the seam 14 to make the bedroll protector 100 completely waterproof.

The zipper arrangement 28 may be a heavy duty two pull nylon zipper backed with an adhesive tape to prevent the entry of water or moisture. In one embodiment of the present invention the zipper arrangement 28 is a waterproof ziplock zipper.

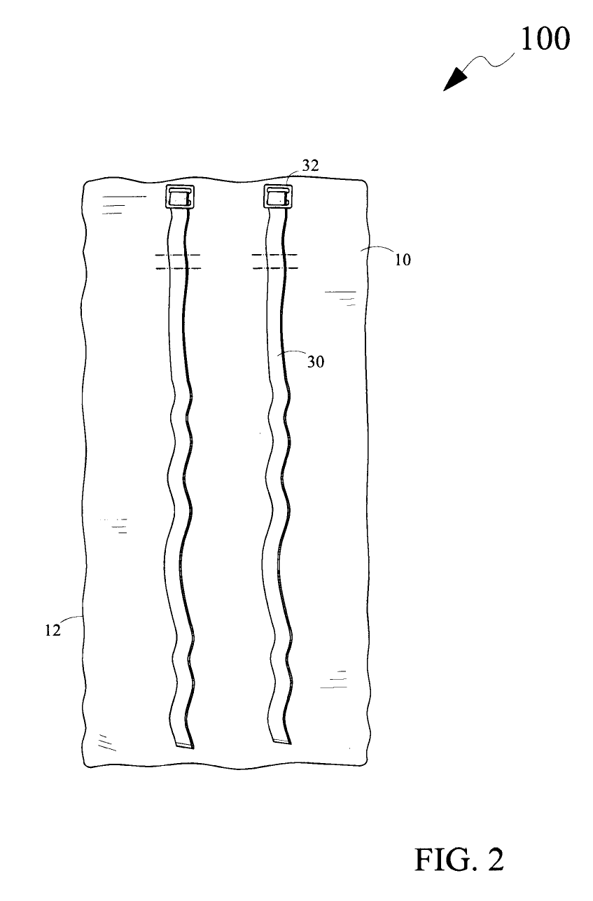

The bedroll protector 100 may be further provided with a strap arrangement comprising a strap 30 and a connector 32 to secure the bedroll protector 100 in a rolled up position (See FIGS. 2 & 5). The strap 30 may be made from any material providing sufficient strength to hold the bedroll protector 100 in the rolled position, for example, nylon webbing, polypropylene and other sturdy materials. In one embodiment of the present invention, the strap 30 is a compression strap to compress the size of the bedroll protector 100 in the rolled position. The connector 32 may be a snap-in connector, ladder lock, buckle, or any other suitable connector known in the art. The strap arrangement may be a entity separate from the bedroll protector 100 or may be attached to the bedroll protector 100 at the lower surface 10.

Additionally, the bedroll protector 100 may be provided with suffocation warning labels adhered at least on one side of the upper portion 20.

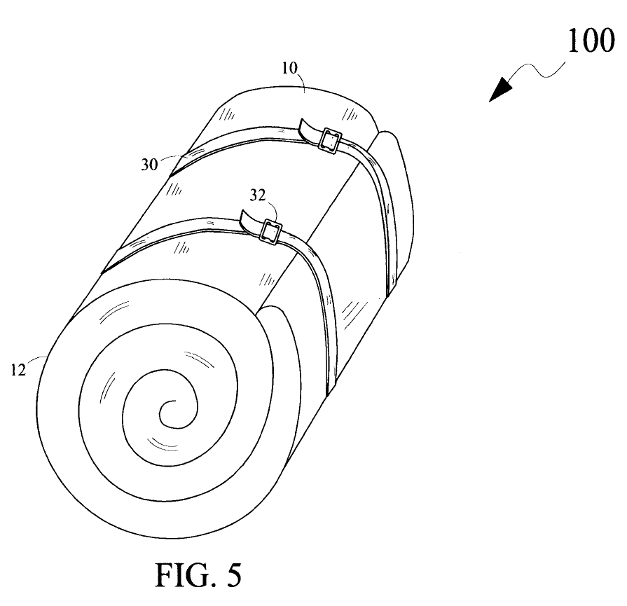

In use, the bedroll protector 100 is laid down on a ground surface in a manner so that the lower portion 10 rests on the ground. The zipper arrangement 28, connecting the three sides 22a, 22b and 22c of the flap 22 with the adjoining three sides 24a, 24b and 24c of the slot 24, is opened. Once the zipper arrangement 28 is completely opened, the flap 22 folds over to the side of the upper portion 20. A bedroll 40 is inserted through the slot 24 into the hollow space between the lower portion 10 and the upper portion 20 and spread out through out the length and breadth in the hollow space therebetween. Thereafter, the three sides 22a, 22b and 22c of the flap 22 may once again be disposed over the three sides 24a, 24b and 24c of the slot 24 and removably engaged thereto using the zipper arrangement 28. The bedroll protector 100 may then be rolled into a carrying configuration as shown in FIG. 5. The bedroll protector 100 is secured in a rolled position by the strap arrangement. The strap 30 is wound around the rolled up bedroll protector 100 and removably coupled with the connector 32. The strap arrangement may be adjusted as necessary to tighten or loosen the bedroll protector 100. The bedroll protector 100 in a rolled position forms a cylindrical configuration and may be easily transported or carried by a user. The bedroll protector 100 may be strapped to a backpack, motorcycle, horseback, ATV, tossed in a canoe, the back of a truck, a car trunk and the like.

In addition, the bedroll protector 100 may be used as a mat in an unrolled position. When unrolled and laid on a ground, the zipper arrangement 28 is opened and the flap 22 is folded to one side. The bedroll protector 100 provides a waterproof barrier between the ground and the bedroll 40. Furthermore, the slot 24 configures a bath-tub feature, as the sides of the slot 24 remains in an elevated position, thereby preventing water from entering from the sides of the bedroll protector 100. The configuration of the bedroll protector 100 is such that to prevent the bedroll 40 from slipping off the bedroll protector 100. The flap 22 may be used to hold various items, for example, books, food material, clothes and others, as the flap 22 is also waterproof.

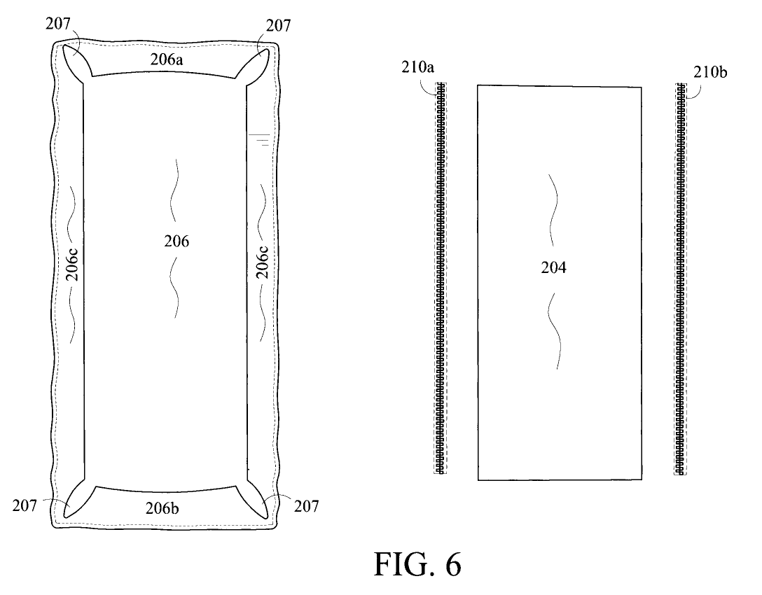

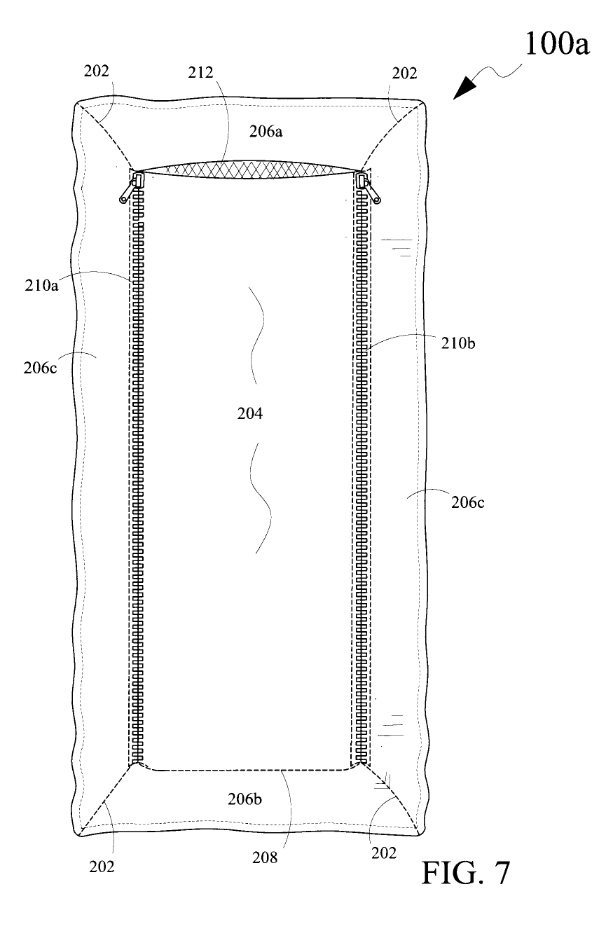

In another embodiment, a bedroll protector 100a comprises an elongated substantially rectangular sheet of waterproof material 206 and a sheet of water-resistant breathable material 204. FIG. 6 depicts this embodiment in a disassembled state. The sheet of waterproof material 206 is preferably flexible and non-susceptible to extreme temperature conditions. In one embodiment of the present invention, the sheet of waterproof non-breathable material 206 is flexible polyethylene with a fineness of 1,000 deniers and being capable of withstanding temperature as low as −70° F. The sheet of waterproof material 206 further comprises peripheral flaps 206a 206b and 206c that are formed by making a diagonal cut 207 starting at each corner of the waterproof material 206 and continuing toward the inner portion of the waterproof material 206 at an angle of 45 degrees with respect to each corner of the sheet of waterproof material 206. Preferably, the cuts 207 will be four to eight inches in length. After the cuts 207 have been made, the flaps 206a 206b and 206c are folded toward each other and attached by way of heat-sealed seams 202 (shown in FIG. 7).

The water-resistant material 204 of the bedroll protector 100a comprises a substantially rectangular elongated sheet. The longer sides of sheet have complementary engagement features 210a capable of removably engaging with engagement features 210b on the flaps 206c of the waterproof material sheet 206. In one embodiment, the engagement features and the complementary engagement features configure a zipper arrangement 210 for securing water-resistant material 204 to the flaps 206c of the waterproof material sheet 206. The water resistant material 204 is further attached to the flap 206b waterproof material sheet 206 by way of a sewn seam 208 (as shown in FIG. 7). The remaining edge of the water resistant material 204 is proximate to the remaining flap 206a of the waterproof material, but does not attach thereto.

As shown in FIG. 7, the waterproof material sheet 206 and water-resistant material 204 are joined by a sewn seam 208 proximate to one end of the protector 100a. The water-resistant material 204 otherwise removably engages with the waterproof material 206 by way of zipper arrangements 210 along two edges of the water-resistant material 204 and the flaps 206c of the waterproof material 206. The user may unzip the zippers to expose the interior region of the bedroll protector 100a for purposes of receiving a bedroll (not shown) in the interior region of the protector 100a. After the bedroll is received in the interior region of the protector 100a, the user may close the zipper arrangement 210 to protect the bedroll from the elements. The edge of the water resistant material 204 proximate to the flap 206a of the waterproof material 206 not attaching to the flap 206a forms an opening 212 that permits the user's head to receive access to breathable air while the remainder of the user's body and bedroll remain protected from the elements inside the interior region of the protector 100a. The opening 212 also reduces the risk of suffocation of a user while the user is inside the closed protector 100a.

The water-resistant material sheet 204 of the bedroll protector 100a comprises any suitable breathable water-resistant material known in the art, including, but not limited to, Gore-Tex, Entrant, Xalt, Ultrex, Storm-Tech. The water-resistant material 204 of the protector 100a allows the user to close the protector 100a after a bedroll is received therein and receive protection from the elements while still allowing moisture from the user's body to leave the interior of the bedroll protector 100a.

The zipper arrangement 210 of the protector 100a may be a heavy duty pull nylon zipper backed with an adhesive tape to prevent the entry of water or moisture. In one embodiment of the present invention the zipper arrangement 210 is a waterproof ziplock zipper.

The protector 100a may be further provided with a strap arrangement comprising a strap and a connector to secure the bedroll protector 100a in a rolled up position (See FIGS. 2 & 5). The strap may be made from any material providing sufficient strength to hold the bedroll protector 100a in the rolled position, for example, nylon webbing, polypropylene and other sturdy materials. In one embodiment of the present invention, the strap is a compression strap to compress the size of the bedroll protector 100a in the rolled position. The connector 32 may be a snap-in connector, ladder lock, buckle, or any other suitable connector known in the art. The strap arrangement may be a entity separate from the bedroll protector 100a or may be attached to the bedroll protector 100a on the underside of the waterproof material sheet 206 (not shown.)

From the foregoing, it may be seen that the bedroll protector 100 affords several advantages including but not limited to compact storage of bedrolls, reduced size when rolled for transportation and storage, and reduced likelihood of damage to the bedroll either from water or snags or tearing, and usage as a mat when in unrolled position. The bedroll protector 100 may also be used for transportation of game animals and game fish, storage of household items like clothes, outdoor furniture, cushions, books and the like.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such omission and substitutions are intended to cover the application or implementation without departing from the spirit or scope of the claims of the present invention.

What is claimed is:

1. A bedroll protector, comprising:
an elongated substantially rectangular bag body comprising
a lower portion configuring a perimeter edge, and
an upper portion integrally connected to the lower portion at the perimeter edge, the upper portion having a flap openable about the upper portion, in a manner such that the flap upon opening configures a slot for receiving a bedroll therethrough and onto the lower portion.

2. The bedroll protector of claim 1, wherein the flap is openable about the upper portion using a zipper arrangement.

3. The bedroll protector of claim 1, wherein the upper portion and the lower portion are integrally connected at a seam along the perimeter edge using at least one of stitching and electronic heat sealing.

4. The bedroll protector of claim 1, wherein the bedroll protector configures a double polylaminated construction.

5. The bedroll protector of claim 1, wherein the bedroll protector is made up of polyethylene.

6. The bedroll protector of claim 1, further comprising a strap arrangement for securing the bedroll within the bedroll protector in a rolled up position.

7. A bedroll protector comprising
a substantially rectangular elongated sheet of waterproof material, and
a substantially rectangular elongated sheet of water-resistant material attached thereto.

8. The bedroll protector of claim 7, wherein the attachment between the sheet of waterproof material and water-resistant material comprises
a sewn seam adjoining one edge of the waterproof material to one edge of the water-resistant material, and
a zipper arrangement along two of the edges of the waterproof material and two complementary edges of the water-resistant material,
wherein the edges of the waterproof and water-resistant materials comprising the zipper arrangement are perpendicular to the edges of the waterproof and water resistant materials comprising the sewn seam.

9. The bedroll protector of claim 7, further comprising a strap arrangement for securing the bedroll within the bedroll protector in a rolled up position.
